(19) United States
(12) Patent Application Publication
(10) Pub. No.: US 2015/0106531 A1
(43) Pub. Date: Apr. 16, 2015

(54) MULTICAST OF STREAM SELECTION FROM PORTABLE DEVICE

(71) Applicant: Nagravision S.A., Cheseaus-sur-Lausanne (CH)

(72) Inventor: Ramachandra Chakenalli Nanjegowda, Bangalore (IN)

(73) Assignee: Nagravision S.A., Cheseaux-sur-Lausanne (CH)

(21) Appl. No.: 14/054,341

(22) Filed: Oct. 15, 2013

(51) Int. Cl. H04L 29/06

(52) U.S. Cl. CPC H04L 65/60
USPC 709/231

(57) ABSTRACT

To view media, a user may select a media stream by operating a portable device that controls a media presentation device. The portable device may be configured to multicast this stream selection to both the media presentation device and a selection analysis machine. The remote control may have or include both an infrared emitter and a cellular telephone, and the stream selection may be sent both to the media presentation device and to the selection analysis machine. The selection analysis machine may receive and store stream selections over a period of time, and these aggregated stream selections may form all or part of a profile of a user or a group of users who use the media presentation device. This profile may indicate viewing habits and choices of one or more users of the media presentation device, and the selection analysis machine may analyze this profile.

### TECHNICAL FIELD

The subject matter disclosed herein generally relates to the processing of data. Specifically, the present disclosure addresses systems and methods to facilitate multicast of a stream selection from a portable device.

### BACKGROUND

Contemporary media viewing often involves a user selecting a media stream and viewing a presentation of the media stream on a display screen. For example, various media stream sources may provide their respective media streams to a media multiplexer, which may combine the media streams into a single datastream for provision to a media presentation device (e.g., a set-top box (STB)). The set-top box may allow the user to select one of the multiplexed media streams for display on the display screen. The media presentation device may be operable using a portable device, such as a remote control, that allows the user to select a media stream without physically touching the media presentation device. Media streams may be selected sequentially, and a first selected stream may be later replaced by a second selected stream. Switching from one selected media stream to another may be referred to as “changing channels.”

For example, supposing the media presentation device is causing a first media stream to the presented on the display screen, the remote control may be operated by the user to transmit a line-of-sight (e.g., infrared, visible light, or laser) “channel change” command that indicates a second media stream (e.g., channel up, channel down, or go to a numerically identified channel) to the media presentation device. The media presentation device may respond to this command by ceasing presentation of the first media stream and initiating presentation of the second media stream.

### BRIEF DESCRIPTION OF THE DRAWINGS

Some embodiments are illustrated by way of example and not limitation in the figures of the accompanying drawings.

FIG. 1 is a network diagram illustrating a network environment suitable for multicast of a stream selection from a portable device, according to some example embodiments.

FIG. 2 is a block diagram illustrating components of a selection analysis machine, according to some example embodiments.

FIG. 3-6 are block diagrams illustrating components of a portable device, according to some example embodiments.

FIG. 7-8 are flowcharts illustrating operations of the portable device in performing a method of multicasting a stream selection from the portable device, according to some example embodiments.

FIG. 9-10 are flowcharts illustrating operations of the selection analysis machine in performing a method of processing a multicast stream selection received from the portable device, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods and systems are directed to facilitating a multicast of stream selection from a portable device (e.g., a handheld device, such as a remote control or a smart phone, or a wearable device, such as a smart watch or smart glasses) to multiple destinations. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

To view media, a user may select a media stream by operating a portable device that controls a media presentation device. For example, the user may choose a channel to view by activating (e.g., pressing) a button (e.g., a channel change button or a channel jump button) on a remote control that is configured to control an STB that receives (e.g., via a cable television network, satellite television network, or the Internet) a multiplexed datastream and cause one or more selected media streams to be presented on a display screen (e.g., television or other video monitor). Traditionally, there has been no path by which this selection of the media stream (e.g., this channel change command or other stream selection command) can be transmitted to a selection analysis machine for storage and analysis. However, according to the methods and systems described herein, the portable device may be configured to multicast this stream selection (e.g., stream selection command) to both the media presentation device and a selection analysis machine.

As an example, the remote control may have or include both an infrared (IR) emitter and a cellular telephone (e.g., a radio frequency (RF) transceiver configured for cellular telephone communications), and the stream selection may be sent both to the media presentation device and to the selection analysis machine contemporaneously (e.g., simultaneously, or within one, two, five, ten, or fifteen seconds of each other). In some example embodiments, this “contemporaneous” sending of the stream selection to both destinations may be fulfilled by sending the stream selection to the selection analysis machine during a latency period in which the media presentation device responds to the stream selection (e.g., so that the stream announced machine receives the stream selection before the media presentation device can respond to another stream selection from the user).

Some example embodiments of the remote control use a visible light emitter, a laser, or some other line-of-sight signal generator, instead of an IR emitter. The selection analysis machine may receive and store stream selections over a period of time, and these aggregated stream selections may form all or part of a profile of a user or a group of users (e.g., a household of people who use the media presentation device). This profile may indicate viewing habits and choices of one or more users of the media presentation device. Accordingly, the selection analysis machine may analyze this profile to extract information for various purposes, such as recommending media, recommending products, and advertising.

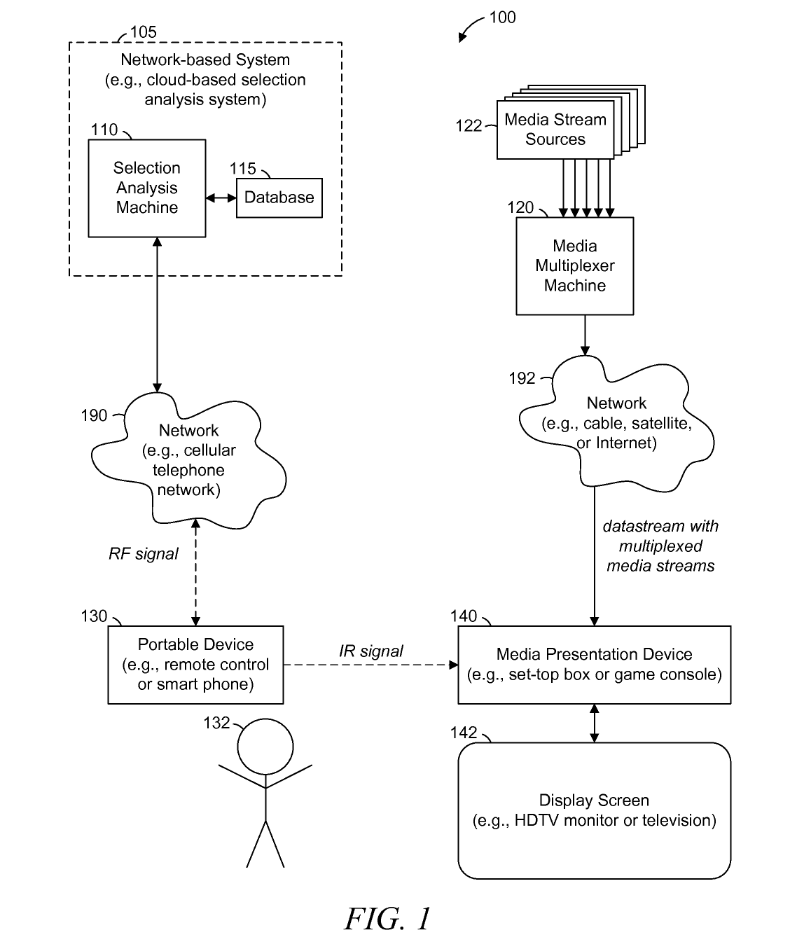

FIG. 1 is a network diagram illustrating a network environment 100 suitable for multicast of a stream selection command from a portable device 130, according to some example embodiments. The network environment 100 includes a selection analysis machine 110 and the portable device 130, which are communicatively coupled to each other via a network 190 (e.g., a first network, which may be or include a cellular telephone network, Voice over Internet Protocol (VOIP) telephone network, a plain old telephone system (POTS) network, or any suitable combination thereof). The selection analysis machine 110 may also be communicatively coupled to a database 115. The selection analysis machine 110, with or without the database 115, may form all or part of a network-based system 105 (e.g., a cloud-based selection analysis server system that provides a service by which stream selection commands may be analyzed for various purposes, such as recommendations or advertising).

The portable device 130 (e.g., a remote control) is configured to control a media presentation device 140 (e.g., an STB), which is configured to present (e.g., display) one or more media streams (e.g., audio streams, video streams, or any suitable combination thereof) to a display screen 142. The display screen 142 may be or include a high definition television (HDTV) monitor, a projector (e.g., internal or external), a television set, a touchscreen, or any suitable combination thereof.

FIG. 1 additionally illustrates another network 192 (e.g., second network, which may be or include a cable television network, satellite television network, the Internet, or any suitable combination thereof). As shown, one or more media stream sources 122 are communicatively coupled to a media multiplexer machine 120 (e.g., at a media head-end facility). The media multiplexer machine 120 is configured to combine (e.g., multiplex or mux) media streams received from the media stream sources 122 into a single datastream that may be provided via the network 192 to a media presentation device 140.

The media presentation device 140 (e.g., an STB, game console, integrated receiver-decoder device (IRD), a digital video recorder (DVR), or any suitable combination of) is configured to cause the display screen 142 to present one or more streams of media. Moreover, the media presentation device 140 may be controllable by the portable device 130. For example, the portable device 130 may be configured to send a stream selection command (e.g., via IR signal or any other line-of-sight signal) to the media presentation device 140. The stream selection command may indicate, relatively (e.g., channel up or channel down) or absolutely (e.g., go to channel 09 or jump to CNN®), a selection of a media stream from among the multiplexed media streams within the datastream that is received from the media multiplexer machine 120. The media presentation device 140 may respond to the stream selection command by causing the display screen 142 to present (e.g., display) the media stream indicated by the stream selection command.

The portable device 130 is configured to control the media presentation device. According to various example embodiments, the portable device 130 may be a handheld device (e.g., a remote control or a smart phone), a wearable device, (e.g., a smart watch or smart eyeglasses), or any suitable combination thereof.

In some example embodiments, the portable device 130 is a remote control (e.g., remote control unit or remote controller device) that corresponds to the media presentation device 140. For example, the portable device 130 may be a factory-supplied remote control that is provided with the media presentation device 140. As another example, the portable device 130 may be a universal remote control that is configured (e.g., via entry of numeric codes) to be compatible with the media presentation device 140.

In certain example embodiments, the portable device 130 is a smart phone (e.g., an iPhone® by Apple Inc.) that is configured to operate the media presentation device 140. For example, the portable device 130 may include an internal or external IR emitter (as an example of a line-of-sight signal generator) and may execute software (e.g., an application, applet, or mobile app) that sends the stream selection command to the media presentation device 140 via an IR signal from the IR emitter.

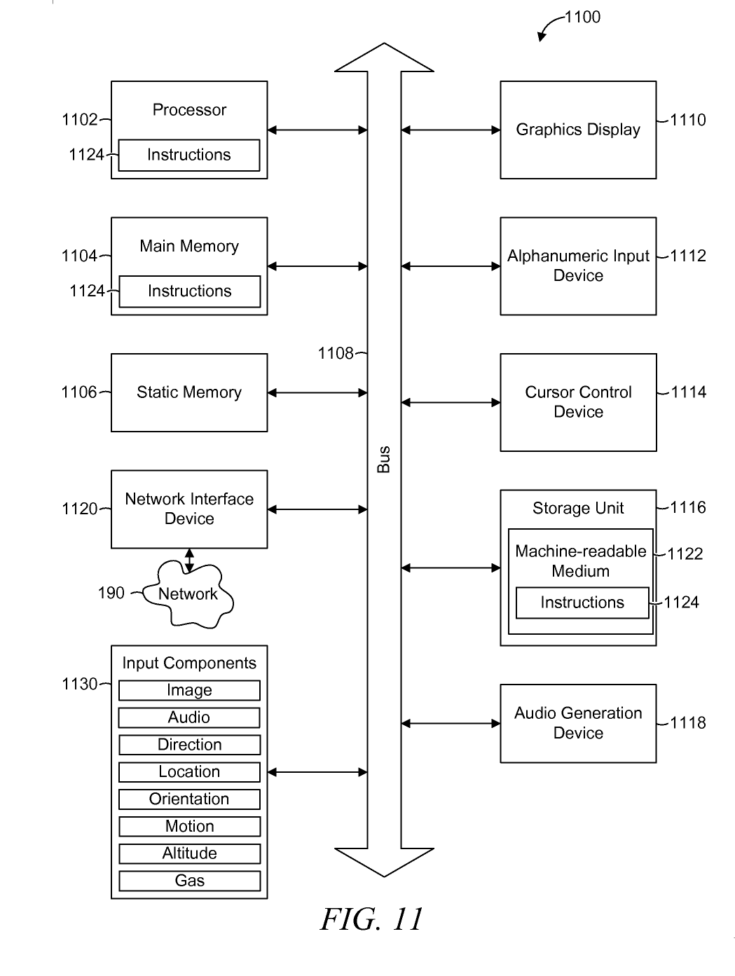

As shown in FIG. 1, the portable device 130 may use an RF signal to communicate with the selection analysis machine 110. For example, the portable device 130 may include an RF transceiver configured to access the network 190 via the RF signal. The selection analysis machine 110 may be configured to access the network 190 via any suitable technology (e.g., wired, wireless, or any suitable combination thereof). The selection analysis machine 110, the media multiplexer machine 120, the portable device 130, the media presentation device 140, and the display screen 142 may each be implemented in a computer system, in whole or in part, as described below with respect to FIG. 11.

Also shown in FIG. 1 is a user 132. The user 132 may be a human user (e.g., a human being), a machine user (e.g., a computer configured by a software program to interact with the portable device 130), or any suitable combination thereof (e.g., a human assisted by a machine or a machine supervised by a human). The user 132 is not part of the network environment 100, but is associated with the portable device 130 and may be a user of the portable device 130. In some example embodiments, the portable device 130 may have multiple users (e.g., multiple members of a household), and these multiple users may share use of the media presentation device 140, the display screen 142, or both. Accordingly, the portable device 130 may be or include a remote control, a smart phone, a desktop computer, a vehicle computer, a tablet computer, a navigational device, or a portable media player that is owned by, or otherwise corresponds to, the user 132 (e.g., alone or with other users).

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the selection analysis machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a POTS network), a wireless data network (e.g., WiFi network or WiMax network), or any suitable combination thereof. Any one or more portions of the network 190 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

The network 192 may be any network that enables the media multiplexer machine 120 to provide the media streams (e.g., combined into a single datastream) to the media presentation device 140. Although in many example embodiments, there is no return path for the media presentation device 140 to communicate data back the media multiplexer machine 120, this is not necessarily true in alternative example embodiments.

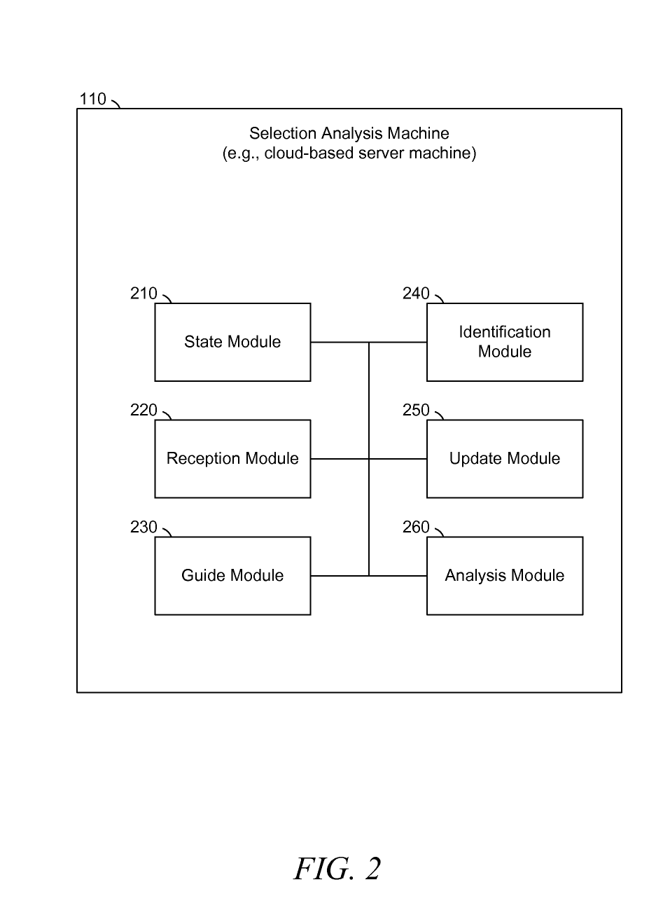

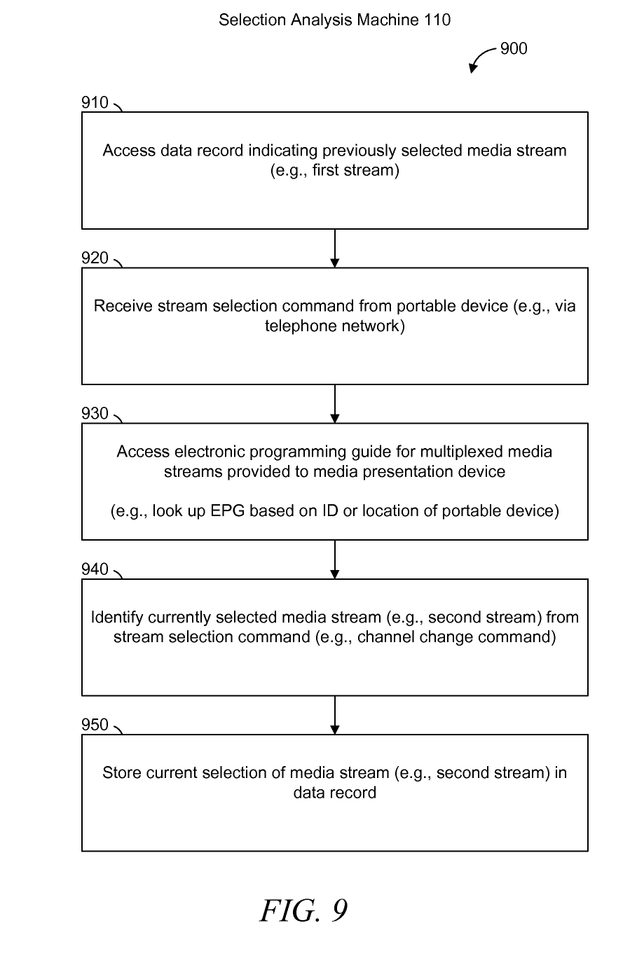

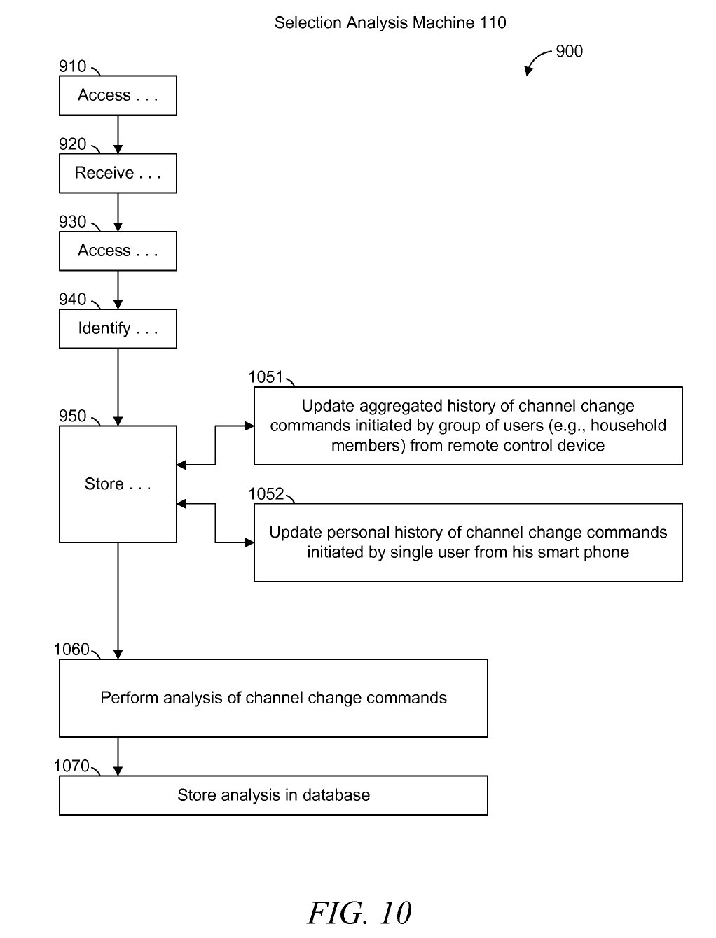

FIG. 2 is a block diagram illustrating components of the selection analysis machine 110, according to some example embodiments. The selection analysis machine 110 may be configured as a cloud-based server machine (e.g., providing a cloud-based service analyzing stream selection commands sent by the user 132, via the portable device 130, to the media presentation device 140). The selection analysis machine 110 is shown as including a state module 210, a reception module 220, a guide module 230, an identification module 240, an update module 250, and an analysis module 260, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. Further details of the modules of the selection analysis machine 110 are described below with respect to FIG. 9-10.

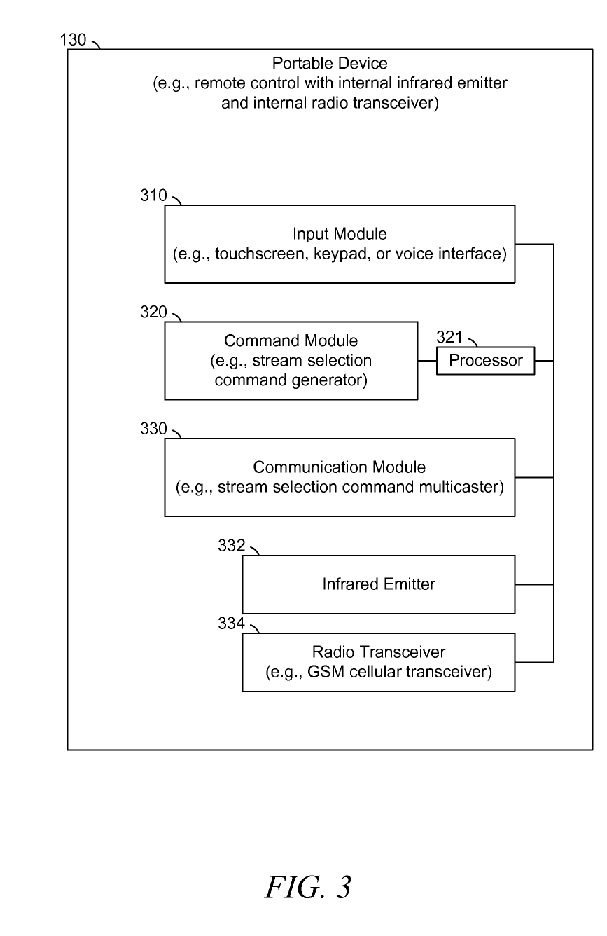

FIG. 3-6 are block diagrams illustrating components of the portable device 130, according to some example embodiments. As shown in FIG. 3, the portable device 130 may be a remote control that includes an input module 310, a command module 320, a processor 321 (e.g., configurable by anyone or more of the modules in the portable device 130), a communication module 330, an IR emitter 332, and a radio transceiver 334, all configured to communicate with each other (e.g., via a bus, shared memory, or a switch).

The input module 310 may be or include a touchscreen, a keypad, a voice interface, or any suitable combination thereof. The command module 320 may be or include a stream selection command generator (e.g., configured to generate a key code that identifies, absolutely or relatively, a media stream selected by the user 132 in operating the portable device 130). The communication module 330 may be or include a multicast of one or more stream selection commands (e.g., channel change commands) and may be configured to control the IR emitter 332 and the radio transceiver 334. The IR emitter 332 (e.g., an IR blaster) is configured to send an IR signal wirelessly to the media presentation device 140. The radio transceiver 334 (e.g., a global system for mobile communications (GSM) cellular transceiver) is configured to access the network 190 via RF communications (e.g., an RF signal). The processor 321 (e.g., a microprocessor) may be configured by any one or more modules of the portable device 130 to perform operations described for those modules.

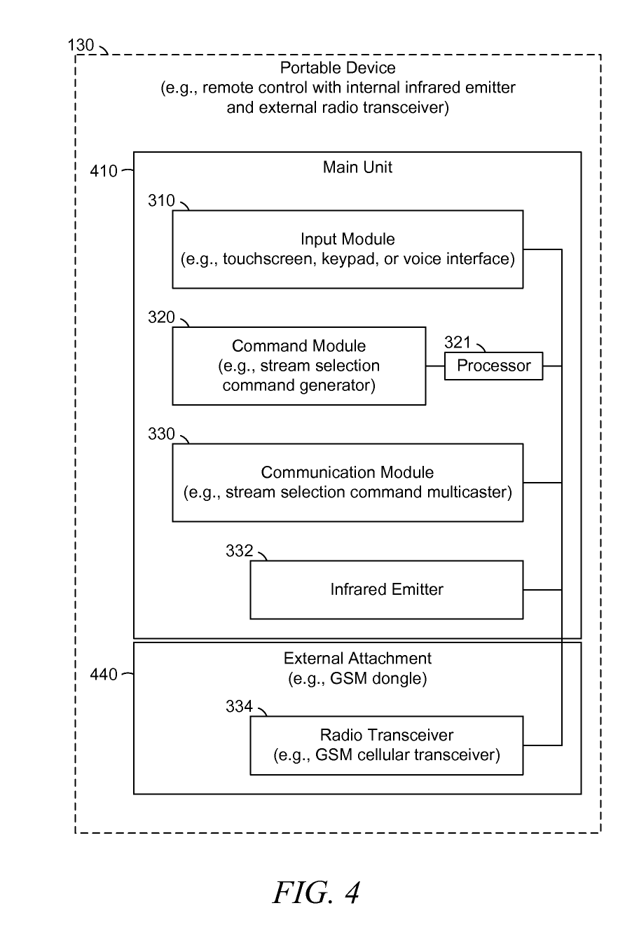

As shown in FIG. 4, the portable device 130 may be a remote control that includes the IR emitter 332 internally within a main unit 410, along with the input module 310, the command module 320, the processor 321, and the communication module 330. However, as shown in FIG. 4, the portable device 130 may have an external attachment 440 (e.g., a GSM dongle) that includes the radio transceiver 334. For example, the external attachment 440 may be or include a GSM dongle that includes the radio transceiver 334 (e.g., a GSM transceiver configured to access the network 190 via RF communications).

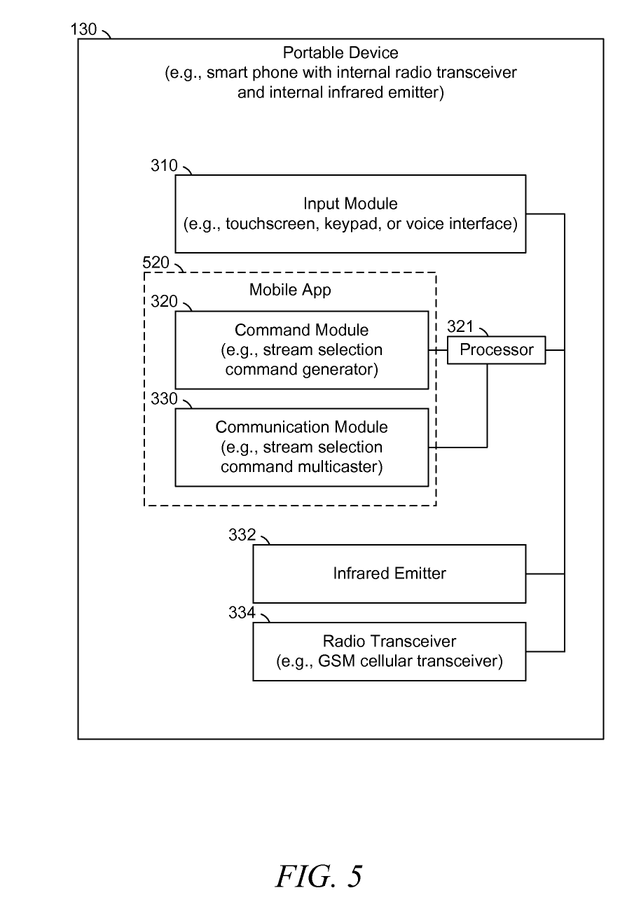

As shown in FIG. 5, the portable device 130 may be a smart phone that internally contains the IR emitter 332 and the radio transceiver 334, along with the input module 310, the command module 320, the processor 321, and the communication module 330. In some example embodiments, the command module 320, the communication module 330, or both, may form all or part of a mobile app 520, which may be stored by the portable device 130 and executed by the processor 321 to perform the operations described herein for the command module 320, the communication module 330, or both.

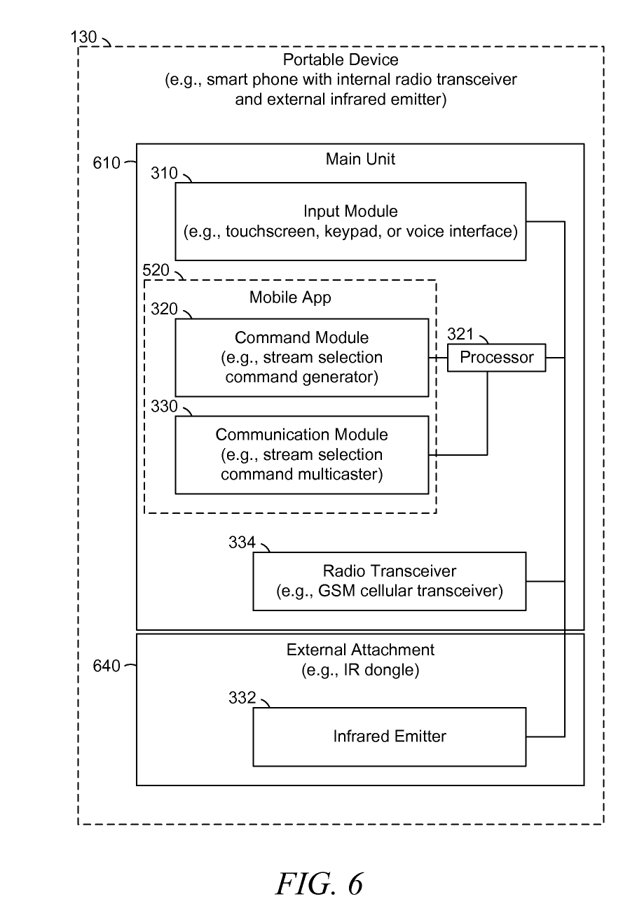

As shown in FIG. 6, the portable device 130 may be a smart phone that includes the radio transceiver 334 internally within a main unit 610, along with the input module 310, the command module 320, the processor 321, and the communication module 330. As noted above, the command module 320, the communication module 330, or both, may form all or part of the mobile app 520, which may be executed by the processor 321. However, as shown in FIG. 6, the portable device 130 may have an external attachment 640 (e.g., an IR dongle) that includes the IR emitter 332. For example, the external attachment 640 may be or include an IR dongle that includes the IR emitter 332 (e.g., an IR blaster configured to send an IR signal to the media presentation device 140).

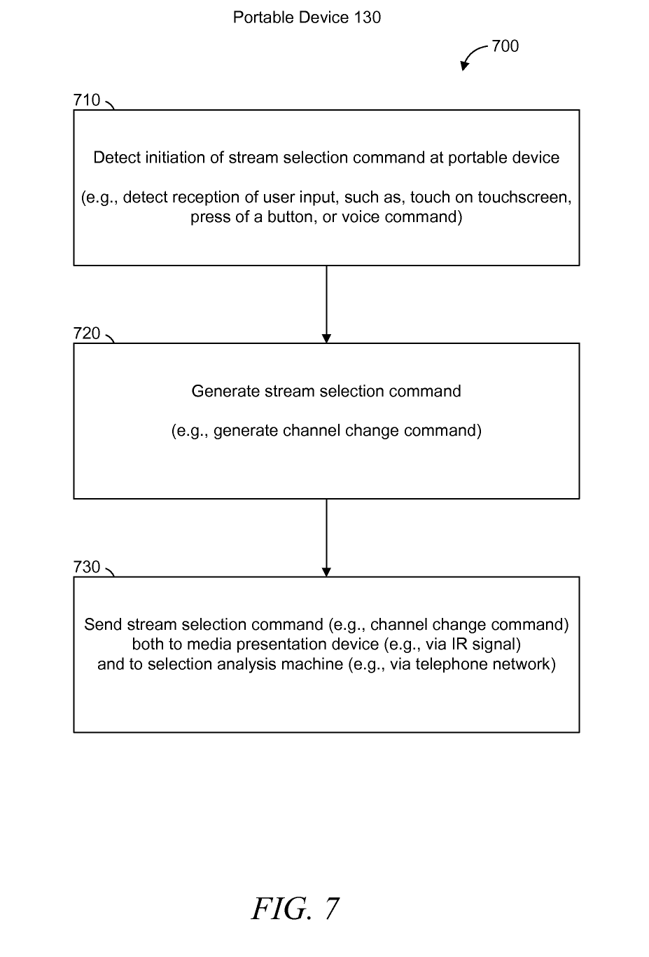

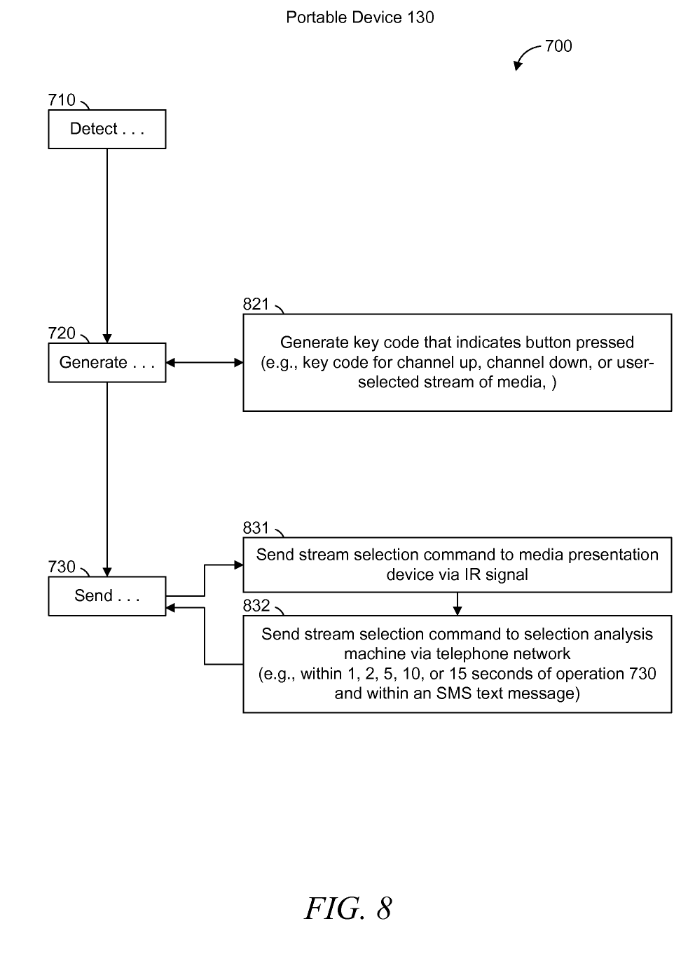

FIG. 7-8 are flowcharts illustrating operations of the portable device 130 in performing a method 700 of multicasting a stream selection command from the portable device 130, according to some example embodiments. Operations in the method 700 may be performed by the portable device 130 using modules described above with respect to FIG. 3-6. As shown in FIG. 7, the method 700 includes operations 710, 720, and 730.

In operation 710, input module 310 detects an initiation of a stream selection command at the portable device 130. The stream selection command (e.g., channel change command) is a command to select a media stream, and the stream selection command may identify a media stream that is selected (e.g., by the user 132) for presentation by the media presentation device 140, the display screen 142, or any suitable combination thereof.

The stream selection command may be detected from a user input (e.g., by the user 132) that originated on the portable device 130. According to various example embodiments, operation 710 is performed by detecting reception of a user input generated by the user 132 and submitted by the user 132 to the portable device 130 while manipulating the portable device 130. Detecting the initiation of the stream selection command may therefore include receiving such a user input or detecting that such a user input has been received. In some example embodiments, initiation of the stream selection command also includes causing operation 720 to be performed.

For example, supposing the input module 310 includes a keypad with a channel up button, the user 132 may activate (e.g., press) the channel up button, which may initiate a stream selection command configured to cause the media presentation device 140 to select and present an incremented channel on the display screen 142. In such a situation, operation 710 may include detecting the activation (e.g., the press) of the channel up button.

As another example, if the input module 310 includes a touchscreen, the user 132 may touch a channel down button displayed on the touchscreen, which may initiate a stream selection command configured to cause the media presentation device 140 to select and present a decremented channel on the display screen 142. In this situation, operation 710 may include detecting the touch on the channel down button.

As a further example, where the input module 310 includes a voice interface, user 132 may speak (e.g., as a voice command) an identifier of a media stream (e.g., a television channel number or name) into a microphone monitored by the voice interface, which may initiate a stream selection command configured to cause the media presentation device 140 to select and present the identified media stream on the display screen 142. In such a situation, operation 710 may include detecting reception or recognition of a voice command that includes the identifier of the media stream.

In operation 720, the command module 320 generates the stream selection command, the initiation of which was detected in operation 710. Operation 720 may be performed in response to operation 710, and operation 720 may include determining a code (e.g., a key code) that, when received by the media presentation device 140, causes the media presentation device 140 to switch to the media stream identified by the stream selection command and caused the display screen 142 to present that identified media stream. The code may indicate that a button (e.g., a channel up button, a channel down button, or an enter button after numeric buttons have been pressed to submit a channel number) was pressed on a keypad of the portable device 130 (e.g., a keypad of the input module 310). In some example embodiments, operation 720 includes accessing (e.g., looking up) the code from a table stored by the portable device 130. In alternative example embodiments, operation 720 includes determining (e.g., generating) the code based on one or more user inputs detected in operation 710.

In operation 730, the communication module 330 causes the IR emitter 332 and the radio transceiver 334 to contemporaneously (e.g., simultaneously or nearly simultaneously) multicast the stream selection command (e.g., generated in operation 720) from the portable device 130 to the media presentation device 140. The contemporaneous multicasting of stream selection command may include sending the stream selection command from the IR emitter 332 to the media presentation device 140 via an IR signal and sending the same stream selection command from the radio transceiver 334 to the selection analysis machine 110 via the network 190 (e.g., using an RF signal to access the network 190). The two transmissions may occur within one, two, five, 10, or 15 seconds of each other and still be considered “contemporaneous” and “multicast,” as these terms are used herein.

As shown in FIG. 8, the method 700 may include one or more of operations 821, 831, and 832. Operation 821 may be performed as part (e.g., a precursor task, a subroutine, or a portion) of operation 720, in which the command module 320 generates the stream selection command. The stream selection command may be generated in the form of a code (e.g., key code or channel identifier). In operation 821, the command module 320 determines (e.g., generates) such a code. In some example embodiments, the code is a key code that indicates a button that was pressed on the portable device 130 to initiate the stream selection command. For example, the button may be a channel up button (e.g., for incrementing a television channel), channel down button (e.g., for decrementing a television channel), or an enter button (e.g., for submitting a channel number entered via a keypad into the portable device 130). The pressing of this button may be detected in operation 710 as the initiation of the stream selection command. In other example embodiments, the code is a channel change code that includes a channel identifier, where such a channel identifier indicates the selected media stream.

One or both of operations 831 and 832 may be performed as part of operation 730, in which the communication module 330 multicasts the stream selection command to both the media presentation device 140 (e.g., via IR signal) and the selection analysis machine 110 (e.g., via the network 190, which may be a cellular telephone network). In operation 831, the communication module 330 causes the IR emitter 332 to send the stream selection command (e.g., in the form of a code, as discussed above with respect to operation 821) to the media presentation device 140 via an IR signal. Accordingly, the IR emitter 332 sends the stream selection command, which is received by the media presentation device 140.

In operation 832, communication module 330 causes the radio transceiver 334 to provide the selection analysis machine 110 with the exact same stream selection command that was sent in operation 831. Accordingly, the communication module 330 may cause the radio transceiver 334 to send the stream selection command to the selection analysis machine 110 via the network 190 (e.g., cellular telephone network). In some example embodiments, the communication module 330 includes (e.g., packages) the stream selection command (e.g., in the form of a code, as discussed above with respect operation 821) within a text message (e.g., formatted for short message service (SMS) communication). Accordingly, the communication module 330 may cause the radio transceiver 334 to send the stream selection command to the selection analysis machine 110 via SMS text message.

FIG. 9-10 are flowcharts illustrating operations of the selection analysis machine 110 in performing a method 900 of processing the multicast stream selection command received from the portable device 130, according to some example embodiments. Operations in the method 900 may be performed by the selection analysis machine 110 using modules described above with respect to FIG. 2. As shown in FIG. 9, the method 900 includes operations 910, 920, 930, 940, and 950.

In operation 910, the state module 210 accesses a data record (e.g., from the database 115). The data record may indicate a previously selected media stream (e.g., a first stream). For example, the data record may indicate a previously watched television channel or a currently watched current television channel, as previously selected by the user 132 and caused by the media presentation device 140 to be presented on the display screen 142. The previously selected media stream may have been selected from among a multiplexed set of media streams (e.g., combined into a single datastream) that the media presentation device 140 received from the media multiplexer machine 120 via the network 192.

In operation 920, the reception module 220 receives the stream selection command that was sent from the portable device 130 (e.g., via the network 190, which may be a telephone network) in operation 730 of the method 700. As noted above, the received stream selection command is the exact same stream selection command that was sent (e.g., multicast) from the portable device 130 (e.g., via an IR signal) to the media presentation device 140 in operation 730 of the method 700.

In operation 930, the guide module 230 accesses an electronic programming guide (EPG) that corresponds to the multiplexed set of media streams (e.g., combined into a single datastream) provided by the media multiplexer machine 120 to the media presentation device 140 (e.g., via the network 192). The EPG may be accessed from the database 115, and the EPG may be accessed based on one or more correspondence relationships between or among the EPG, the multiplexed set of media streams, an attribute of the media presentation device 140 (e.g., serial number, network address, location, or neighborhood channel lineup), an attribute of the portable device 130 (e.g., serial number, network address, or location), and an attribute of the user 132 (e.g., user name, account number, subscription level, or personal channel lineup). Such correspondence relationships may be stored in a table (e.g., within the database 115) and may be accessed (e.g., looked up) by the guide module 230 as part of accessing the EPG for the multiplexed set of media streams.

In operation 940, the identification module 240 identifies the media stream selected by the stream selection command that was received in operation 920. The identification of the media stream may be based on the stream selection command received in operation 920, on the EPG accessed in operation 930, or on both. In some situations, the stream selection command contains a code (e.g., a channel identifier) that absolutely identifies the media stream. In such situations, the identification module 240 may identify the media stream by accessing (e.g., reading) the code from the stream selection command and find a matching code in the EPG. In other situations, the stream selection command contains a code (e.g., a channel up code or channel down code) that indicates the newly selected media stream (e.g., a second stream) only in relation to a previously selected media stream (e.g., the first stream, as discussed with respect operation 910). In these situations, the identification module 240 may identify the newly selected media stream (e.g., newly selected channel) by incrementing or decrementing the previously selected media stream (e.g., previously watched channel or currently watched channel). The EPG may be used by the identification module 240 to identify appropriate (e.g., valid) codes for the media streams provided to the media presentation device 140.

In operation 950, the update module 250 updates the data record accessed in operation 910. In particular, the data record may be updated to indicate the newly selected media stream (e.g., the second stream) identified in operation 940. For example, the updated data record may indicate a newly selected television channel. Moreover, the updated data record may be or include a history of stream selection commands (e.g. channel change commands), with timestamps and date stamps that indicate when the stream selection commands were sent from the portable device 130, received by the selection analysis machine 110, or both. Accordingly, within the data record, operation 950 may add the current stream selection (e.g., with a corresponding timestamp, date stamp, or both) to a sequence of one or more previous stream selections.

As shown in FIG. 10, the method 900 may include one or more of operations 1051, 1052, 1060, and 1070. One or more of operations 1051 and 1052 may be performed as part (e.g., a precursor task, a subroutine, or a portion) of operation 950, in which the update module 250 stores an indication of the currently selected media stream (e.g., first stream) in the data record (e.g., within the database 115).

In operation 1051, as part of updating the data record, the update module 250 updates a group profile that corresponds to the portable device 130, the media presentation device 140, or both. This group profile may be or include an aggregate history of channel change commands that were initiated by a group of users (e.g., user 132 and others) in manipulating the portable device 130 (e.g., a remote control) to control the media presentation device 140. In such a situation, subsequent analysis of this group profile (e.g., in operation 1060) may be performed to extract useful information for various purposes, such as recommendations or advertising.

In operation 1052, as part of updating the data record, the update module 250 updates a personal profile that corresponds to the portable device 130, the media presentation device 140, or both. In some example embodiments, the personal profile corresponds only (e.g., strictly) to the portable device 130, which may be a smart phone that belongs to the user 132. This personal profile may be or include an aggregate history of channel change commands that were initiated by the user 132 in manipulating the portable device 130 to control the media presentation device 140. According to certain example embodiments, the portable device 130 (e.g., a smart phone that includes the IR emitter 332) is used by the user 132 to operate several different media presentation devices (e.g., media presentation device 140), and the personal profile of the user 132 is an aggregate history of channel change commands sent by the user 132 to all of the several media presentation devices.

One or more of operations 1060 and 1070 may be performed subsequent to operation 950, in which the update module 250 stores indication of the currently selected media stream (e.g., first stream) in the data record. In operation 1060, the analysis module 260 performs an analysis of the data record stored in operation 950. In some example embodiments, as noted above with respect to operation 1051, the analysis module 260 may analyze a group profile that aggregates channel change commands initiated by multiple users (e.g., user 132 and others) in manipulating the portable device 130 to control the media presentation device 140. Information extracted from this analysis may be used for various purposes, such as recommendations or advertising to be provided in the future (e.g., in the multiplexed media streams received by the media presentation device 140 from the media multiplexer machine 120).

In certain example embodiments, as noted above with respect operation 1052, the analysis module 260 may analyze a personal profile that aggregates channel change commands initiated by the user 132 in manipulating the portable device 130 to control the media presentation device 140. As noted above, information extracted from this analysis may be used for various purposes, such as recommendations or advertising to be provided in the future (e.g., in the multiplexed media streams received by the media presentation device 140 from the media multiplexer machine 120, or via the network 190 to the portable device 130).

In operation 1070, the analysis module 260 stores the information extracted from the analysis performed in operation 1060. This information may be stored in the database 115 (e.g., as part of the group profile, or as part of the personal profile).

According to various example embodiments, one or more of the methodologies described herein may facilitate a multicast of stream selection command from a portable device (e.g., portable device 130) to both a media presentation device (e.g., media presentation device 140) and a selection analysis machine (e.g., selection analysis machine 110). Moreover, one or more of the methodologies described herein may facilitate capture, storage, and analysis of stream selection commands, even in situations where the media presentation device has no return path to communicate (e.g., forward or report) the stream selection commands received from the portable device. Hence, one or more the methodologies described herein may facilitate extraction of useful information from a profile (e.g., a group profile or a personal profile) that corresponds to the portable device, the media presentation device, or both.

When these effects are considered in aggregate, one or more of the methodologies described herein may obviate a need for certain efforts or resources that otherwise would be involved in capturing, storing, and analyzing stream selection commands sent from a portable device to a media presentation device. Efforts expended by recommendation personnel or advertising personnel in accessing and analyzing such information may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 11 is a block diagram illustrating components of a machine 1100, according to some example embodiments, able to read instructions 1124 from a machine-readable medium 1122 (e.g., a machine-readable storage medium, a computer-readable storage medium, or any suitable combination thereof) and perform any one or more of the methodologies discussed herein, in whole or in part. Specifically, FIG. 11 shows the machine 1100 in the example form of a computer system within which the instructions 1124 (e.g., software, a program, an application, an applet, an app, or other executable code) for causing the machine 1100 to perform any one or more of the methodologies discussed herein may be executed, in whole or in part. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smartphone, a STB, a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touchpad, a trackball, a joystick, a motion sensor, an eye tracking device, or other pointing instrument), a storage unit 1116, an audio generation device 1118 (e.g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered machine-readable media (e.g., tangible and non-transitory machine-readable media). The instructions 1124 may be transmitted or received over the network 190 via the network interface device 1120. For example, the network interface device 1120 may communicate the instructions 1124 using any one or more transfer protocols (e.g., hypertext transfer protocol (HTTP)).

In some example embodiments, the machine 1100 may be a portable computing device, such as a smart phone or tablet computer, and have one or more additional input components 1130 (e.g., sensors or gauges). Examples of such input components 1130 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
detecting an initiation of a stream selection command initiated at a portable device that is configured to send the stream selection command both to a media presentation device via a line-of-sight signal and to a selection analysis machine via a telephone network, the initiation being detected from a user input that originated on the portable device;
generating the stream selection command in response to the initiation of the stream selection command, the generating of the stream selection command being performed by a processor of the portable device; and
sending the stream selection command from the portable device both to the media presentation device via the line-of-sight signal and to the selection analysis machine via the telephone network.

2. The method of claim 1, wherein:
the sending of the stream selection command to both the media presentation device and the selection analysis machine sends the stream selection command to the selection analysis machine within a latency period during which the media presentation device response to the stream selection command.

3. The method of claim 1, wherein:
the user input is an activation of a button on the portable device;
the generating of the stream selection command generates a key code that indicates the button activated on the portable device to initiate the stream selection command.

4. The method of claim 1, wherein:
the sending of the stream selection command sends the selection analysis machine a channel change command that is executable by the media presentation device to select a stream of media and cause a display screen to present a stream of media, the stream of media being selected based on the channel change command from multiple streams of media multiplexed into a datastream that is received by the media presentation device.

5. The method of claim 1, wherein:
the stream selection command is a channel change command; and
the detecting of the initiation of the channel change command detects the user input as at least one of a touch, a button press, or a voice command received by the portable device.

6. The method of claim 1, wherein:
the telephone network is a cellular telephone network; and
the sending of the stream selection command to the selection analysis machine sends the stream selection command within a text message via the cellular telephone network.

7. The method of claim 1, wherein:
the portable device is a handheld remote control device configured to control the media presentation device by sending stream selection commands to the media presentation device via infrared signals according to user inputs generated by a user in manipulating the handheld remote control device,
the handheld remote control device including an internal radio transceiver configured to communicate with the telephone network.

8. The method of claim 1, wherein:
the portable device is a handheld remote control device configured to control the media presentation device by sending stream selection commands to the media presentation device via infrared signals according to user inputs generated by a user in manipulating the handheld remote control device,
the handheld remote control device including an external radio transceiver configured to communicate with the telephone network.

9. The method of claim 1, wherein:
the portable device is a smart phone storing a mobile app that, when executed by the smart phone, causes the smart phone to control the media presentation device by sending stream selection commands to the media presentation device via infrared signals according to user inputs generated by a user in manipulating the smart phone,
the smart phone including an internal infrared emitter configured to communicate data to the media presentation device.

10. The method of claim 1 further comprising:
the portable device is a smart phone storing a mobile app that, when executed by the smart phone, causes the smart phone to control the media presentation device by sending stream selection commands to the media presentation device via infrared signals according to user inputs generated by a user in manipulating the smart phone,
the smart phone including an external infrared emitter configured to communicate data to the media presentation device.

11. A non-transitory machine-readable storage medium comprising instructions that, when executed by one or more processors of a machine, cause the machine to perform operations comprising:
accessing a data record that indicates a previous selection of a first stream from a multiplexed plurality of streams provided to a media presentation device and presentable on a display screen;
receiving a stream selection command via a telephone network from a portable device that generated a stream selection command and sent the stream selection command to the media presentation device via a line-of-sight signal;
accessing an electronic programming guide that corresponds to the multiplexed plurality of streams provided to the media presentation device that received the stream selection command via the line-of-sight signal;
identifying a current selection of a second stream from the multiplexed plurality of streams based on the stream selection command and based on the electronic programming guide; and
storing the current selection of the second stream in the data record that stores the previous selection of the first stream.

12. The non-transitory machine-readable storage medium of claim 11, wherein:
the storing of the current selection stores an identifier of the second stream with a corresponding identifier of the portable device and a corresponding time at which the stream selection command was received from the portable device.

13. The non-transitory machine-readable storage medium of claim 11, wherein:
the stream selection command is a channel change command;
the portable device is a handheld remote control device configured to control the media presentation device by sending channel change commands to the media presentation device via infrared signals according to user inputs generated by a group of users in manipulating the handheld remote control device; and
the storing of the current selection in the data record updates an aggregate history of channel change commands initiated by the group of users from the handheld remote control device.

14. The non-transitory machine-readable storage medium of claim 11, wherein:
the stream selection command is a channel change command;
the portable device is a smart phone storing a mobile app that, when executed by the smart phone, causes the smart phone to control the media presentation device by sending channel change commands to the media presentation device via infrared signals according to user inputs generated a user in manipulating the smart phone; and
the storing of the current selection in the data record updates a personal history of channel change commands initiated by the user from the smart phone.

15. A portable device comprising:
an input module configured to detect an initiation of a stream selection command initiated at a portable device that is configured to send the stream selection command both to a media presentation device via a line-of-sight signal and to a selection analysis machine via a telephone network, the initiation being detected from a user input that originated on the portable device;
a processor configured by a command module to generate the stream selection command in response to the initiation of the stream selection command, the generating of the stream selection command being performed by a processor of the portable device; and
a communication module configured to send the stream selection command from the portable device both to the media presentation device via the line-of-sight signal and to the selection analysis machine via the telephone network.

16. The portable device of claim 15, wherein:
the communication module, being configured to send the stream selection command, is configured to send the selection analysis machine a channel change command that is executable by the media presentation device to select a stream of media and cause a display screen to present a stream of media, the stream of media being selected based on the channel change command from multiple streams of media multiplexed into a datastream that is received by the media presentation device.

17. The portable device of claim 15, wherein:
the communication module, being configured to send the stream selection command, is configured to send the stream selection command to the selection analysis machine within 10 seconds of sending the stream selection command to the media presentation device.

18. A system comprising:
a state module configured to access a data record that indicates a previous selection of a first stream from a multiplexed plurality of streams provided to a media presentation device and presentable on a display screen;
a reception module configured to receive a stream selection command via a telephone network from a portable device that generated a stream selection command and sent the stream selection command to the media presentation device via a line-of-sight signal;
a guide module configured to access an electronic programming guide that corresponds to the multiplexed plurality of streams provided to the media presentation device that received the stream selection command via the line-of-sight signal;
a processor configured by an identification module to identify a current selection of a second stream from the multiplexed plurality of streams based on the stream selection command and based on the electronic programming guide; and
an update module configured to store the current selection of the second stream in the data record that stores the previous selection of the first stream.

19. The system of claim 18, wherein:
the stream selection command is a channel change command;
the portable device is a handheld remote control device configured to control the media presentation device by sending channel change commands to the media presentation device via infrared signals according to user inputs generated by a group of users in manipulating the handheld remote control device; and
the update module, being configured to store the current selection in the data record, is configured to update an aggregate history of channel change commands initiated by the group of users from the handheld remote control device.

20. The system of claim 18, wherein:
the stream selection command is a channel change command;
the portable device is a smart phone storing a mobile app that, when executed by the smart phone, causes the smart phone to control the media presentation device by sending channel change commands to the media presentation device via infrared signals according to user inputs generated by a user in manipulating the smart phone; and
the update module, being configured to store the current selection in the data record, is configured to update a personal history of channel change commands initiated by the user from the smart phone.
